(19) United States
(12) Patent Application Publication
(10) Pub. No.: US 2013/0248086 A1
(43) Pub. Date: Sep. 26, 2013

(54) FILM SUBSTRATE LIQUID CRYSTAL SEALING METHOD

(71) Applicant: Fujitsu Frontech Limited, Tokyo (JP)

(72) Inventors: Hidenobu HAMADA, Inagi-shi (JP); Katsukiyo KOWATA, Inagi-shi (JP)

(73) Assignee: Fujitsu Frontech Limited, Tokyo (JP)

(21) Appl. No.: 13/898,658

(22) Filed: May 21, 2013

Related U.S. Application Data
(63) Continuation of application No. PCT/JP2010/073462, filed on Dec. 24, 2010.

(51) Int. Cl. G02F 1/1339

(52) U.S. Cl. CPC G02F 1/1339
USPC 156/145

(57) ABSTRACT

A film substrate liquid crystal sealing method includes injecting a liquid crystal material between a first substrate and a second substrate via an opening part formed on the first substrate, the second substrate or combination thereof, injecting a sealing material for sealing the liquid crystal material injected in the injecting of the liquid crystal material via the opening part, and hardening the sealing material in a pressed state by pressing down a portion that protrudes from the opening part of the sealing material injected in the injecting of the sealing material toward an inside of the opening part with a pressing member.

### CROSS-REFERENCE TO RELATED APPLICATION

This application is a continuation application of International Application PCT/JP 2010/073462 filed on Dec. 24, 2010 and designated the U.S., the entire contents of which are incorporated herein by reference.

### FIELD OF THE INVENTION

The embodiment discussed herein is related to a film substrate liquid crystal sealing method for sealing a liquid crystal material injected between first and second substrates.

### BACKGROUND OF THE INVENTION

Conventionally, a liquid crystal panel for making a display by affixing one transparent substrate on which transparent electrodes are disposed to the other transparent substrate so that the electrodes face each other, by sealing a liquid crystal material between the transparent substrates, and by applying a voltage between the electrodes to make the liquid crystal material react is known.

As one method for injecting a liquid crystal material, a method for injecting a liquid crystal material via an opening part arranged in a sealing frame part for affixing the first substrate and the second substrate can be cited (for example, see Patent Document 1).

This injection method is briefly described with reference to FIGS. 4A to 4C and 5A to 5I.

As illustrated in FIGS. 4A to 4C, a first substrate 110 and a second substrate 120, which are respectively composed of a transparent film, are affixed by a rectangular sealing frame part 130. On one of four sides of the sealing frame part 130, an opening part 131 for injecting a liquid crystal material is formed. The sealing frame part 130 seals a liquid crystal material to be described later between the first substrate 110 and the second substrate 120.

The first substrate 110 and the second substrate 120, which are affixed by the sealing frame part 130 as illustrated in FIG. 5A, are accommodated by a housing not illustrated, and the inside of the housing is depressurized, for example, to a vacuum by depressurizing means (depressurized state).

Then, as illustrated in FIG. 5B, the opening part 131 side illustrated in FIGS. 4A and 4B of the sealing frame part 130 is immersed in a liquid crystal material 140 within a liquid crystal reservoir 170 in the depressurized state unchanged.

When the depressurized state of the inside of the housing not illustrated is released to a normal pressure state, an outside atmospheric pressure P is applied to the liquid crystal material 140, which is filled within the sealing frame part 130 as illustrated in FIGS. 5C and 5D. Thereafter, the first substrate 110 and the second substrate 120 are taken out of the liquid crystal material 140 within the liquid crystal reservoir 170 as illustrated in FIG. 5E.

Then, as illustrated in FIG. 5F, the opening part 131 (see FIGS. 4A and 4B) side of the sealing frame part 130 of the first substrate 110 and the second substrate 120 is immersed in a sealing material 151 within a sealing material reservoir 180.

Thereafter, when the first substrate 110 and the second substrate 120 are taken out of the sealing material 151 within the sealing material reservoir 180, the sealing material 151 is adhered to the first substrate 110 and the second substrate 120 as illustrated in FIG. 5G.

Next, an ultraviolet ray irradiation part 160 hardens the adhered sealing material 151 with an ultraviolet ray UV (hardened sealing material 152) as illustrated in FIG. 5. Then, a portion 152′ of the hardened sealing material 152 is removed along surfaces of the first substrate 110 and the second substrate 120.

As another method for injecting a liquid crystal material, a method for injecting a liquid crystal material via an opening arranged on a first substrate or a second substrate can be cited (for example, see Patent Documents 2 and 3). Also with this method, a sealing material is hardened and an unneeded protrusion part is removed similarly to the method for injecting a liquid crystal material via the opening arranged in the sealing frame part as described above.

### SUMMARY OF THE INVENTION

A film substrate liquid crystal sealing method disclosed in this specification includes injecting a liquid crystal material between a first substrate and a second substrate via an opening part formed on the first substrate, the second substrate or combination thereof, injecting a sealing material for sealing the liquid crystal material injected in the injecting of the liquid crystal material via the opening part, and hardening the sealing material in a pressed state by pressing down a portion that protrudes from the opening part of the sealing material injected in the injecting of the sealing material toward an inside of the opening part with a pressing member.

### DESCRIPTION OF THE DRAWINGS

FIG. 1A is a disassembly view of a film substrate for explaining a liquid crystal sealing method according to an embodiment;

FIG. 1B is a plan view of the film substrate for explaining the liquid crystal sealing method according to the embodiment;

FIG. 1C is a cross-sectional view taken along a line A-A of FIG. 1B;

FIG. 2A is a cross-sectional view (No. 1) for explaining the liquid crystal sealing method according to the embodiment;

FIG. 2B is a cross-sectional view (No. 2) for explaining the liquid crystal sealing method according to the embodiment;

FIG. 2C is a cross-sectional view (No. 3) for explaining the liquid crystal sealing method according to the embodiment;

FIG. 2D is a cross-sectional view (No. 4) for explaining the liquid crystal sealing method according to the embodiment;

FIG. 2E is a cross-sectional view (No. 5) for explaining the liquid crystal sealing method according to the embodiment;

FIG. 2F is a cross-sectional view (No. 6) for explaining the liquid crystal sealing method according to the embodiment;

FIG. 2G is a cross-sectional view (No. 7) for explaining the liquid crystal sealing method according to the embodiment;

FIG. 2H is a cross-sectional view (No. 8) for explaining the liquid crystal sealing method according to the embodiment;

FIG. 3A is a cross-sectional view for explaining a shape of an opening part of a substrate in the embodiment;

FIG. 3B is a cross-sectional view for explaining a shape of an opening part of a substrate in a first modification example of the embodiment;

FIG. 3C is a cross-sectional view for explaining a shape of an opening part of a substrate in a second modification example of the embodiment;

FIG. 3D is a cross-sectional view for explaining a shape of an opening part of a substrate in a third modification example of the embodiment;

FIG. 3E is a cross-sectional view for explaining a shape of an opening part of a substrate in a fourth modification example of the embodiment;

FIG. 4A is a disassembly view of a film substrate for explaining a related liquid crystal injection method;

FIG. 4B is a plan view of the film substrate for explaining the related liquid crystal injection method;

FIG. 4C is a cross-sectional view taken along a line B-B of FIG. 4B;

FIG. 5A is a cross-sectional view (No. 1) for explaining the related liquid crystal injection method;

FIG. 5B is a cross-sectional view (No. 2) for explaining the related liquid crystal injection method;

FIG. 5C is a cross-sectional view (No. 3) for explaining the related liquid crystal injection method;

FIG. 5D is a cross-sectional view (No. 4) for explaining the related liquid crystal injection method;

FIG. 5E is a cross-sectional view (No. 5) for explaining the related liquid crystal injection method;

FIG. 5F is a cross-sectional view (No. 6) for explaining the related liquid crystal injection method;

FIG. 5G is a cross-sectional view (No. 7) for explaining the related liquid crystal injection method;

FIG. 5H is a cross-sectional view (No. 8) for explaining the related liquid crystal injection method; and

FIG. 5I is a cross-sectional view (No. 9) for explaining the related liquid crystal injection method;

### DESCRIPTION OF EMBODIMENTS

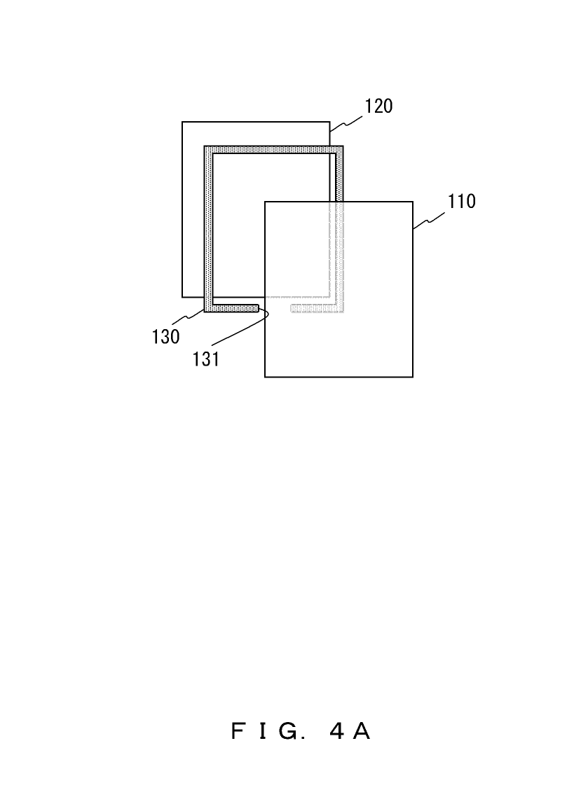

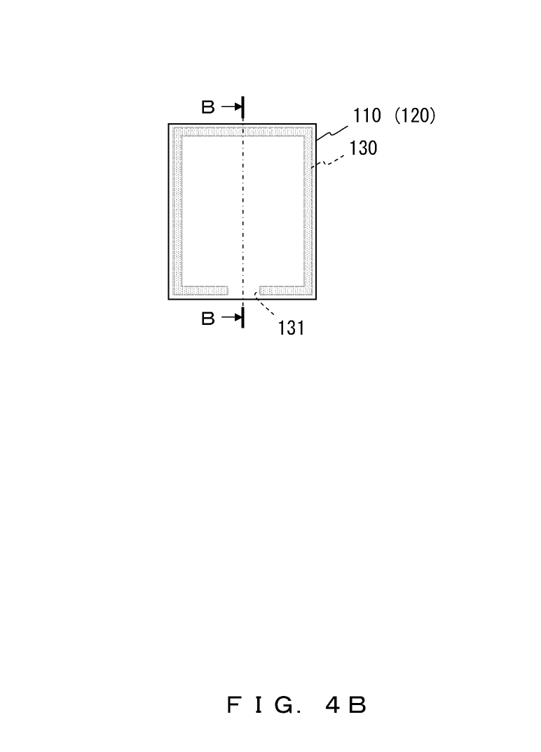

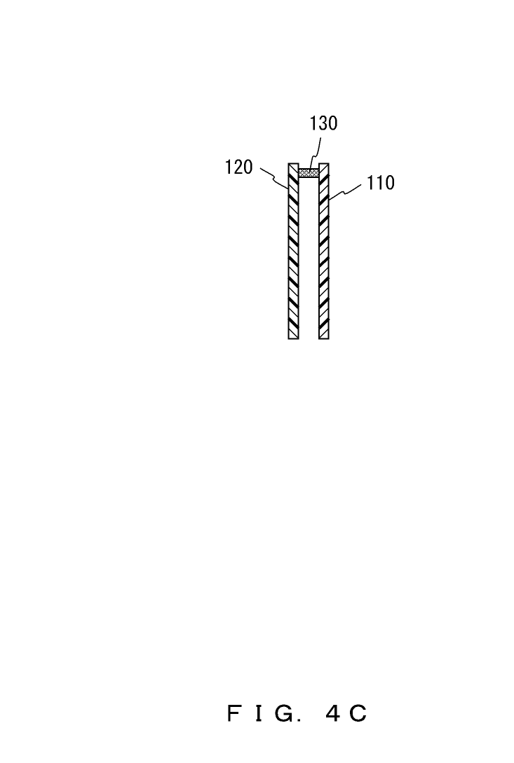

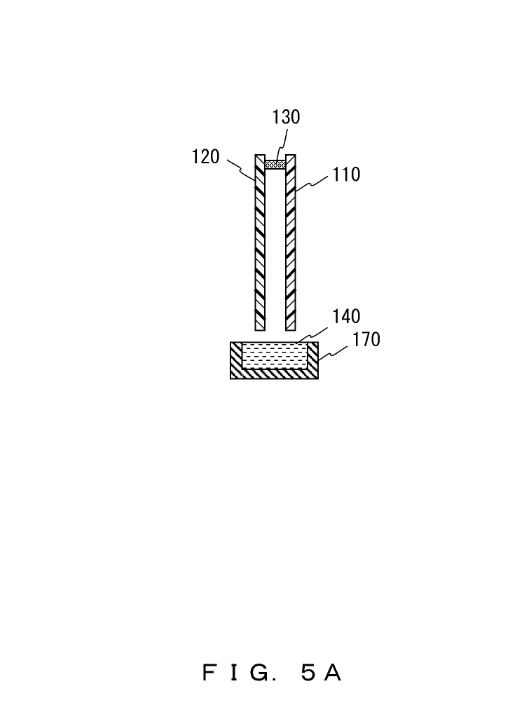

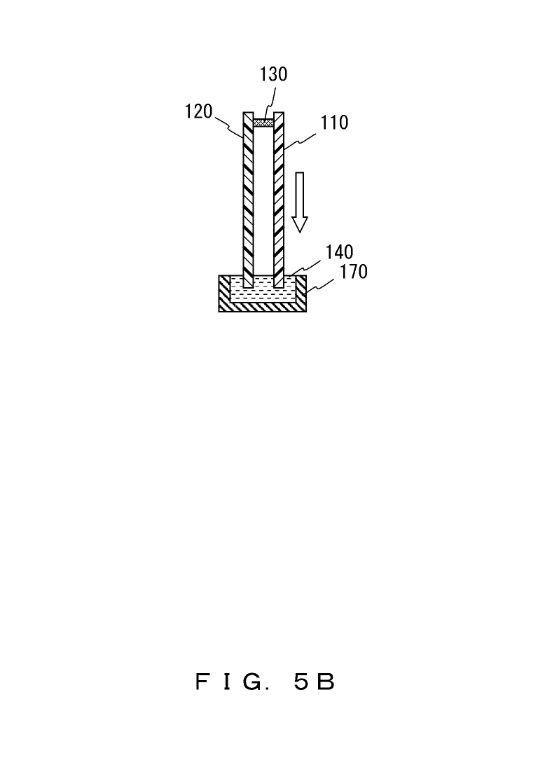

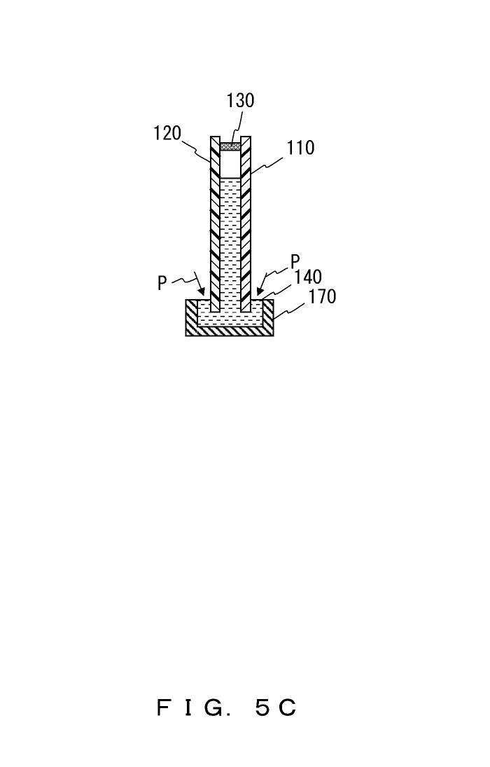

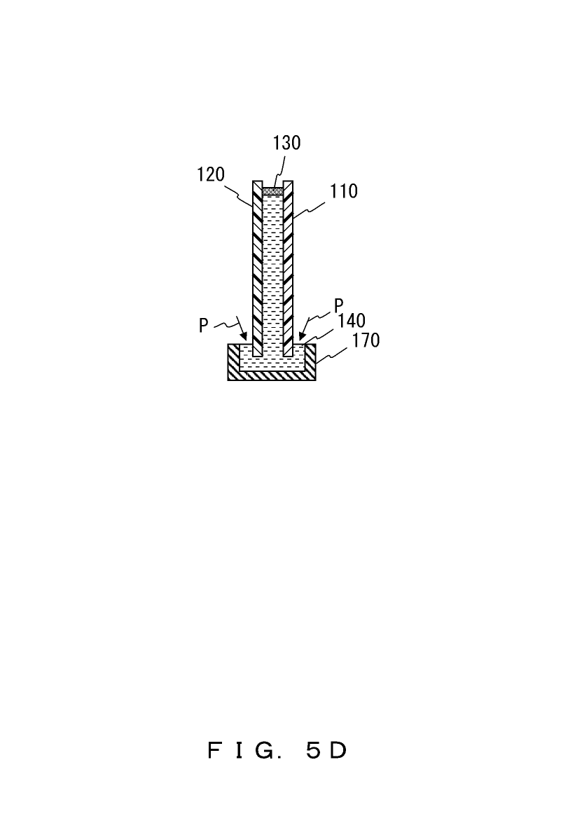

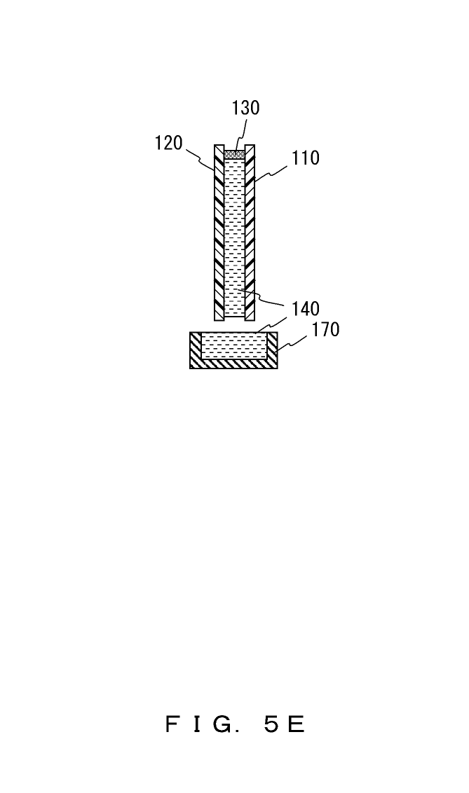

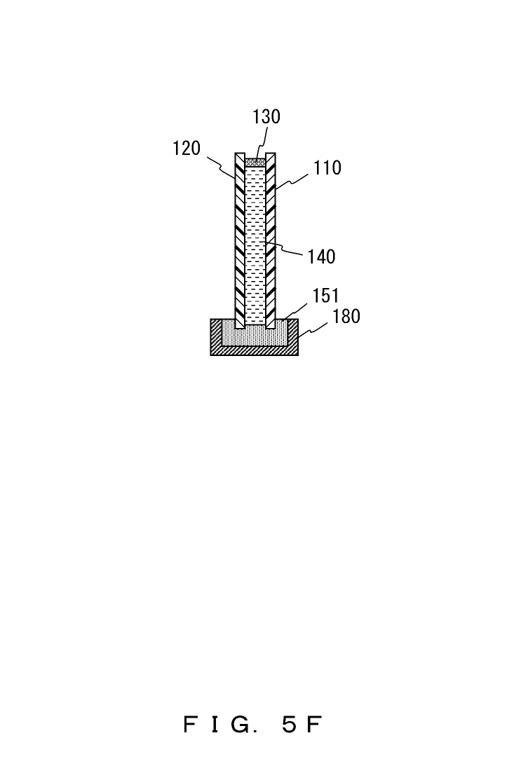

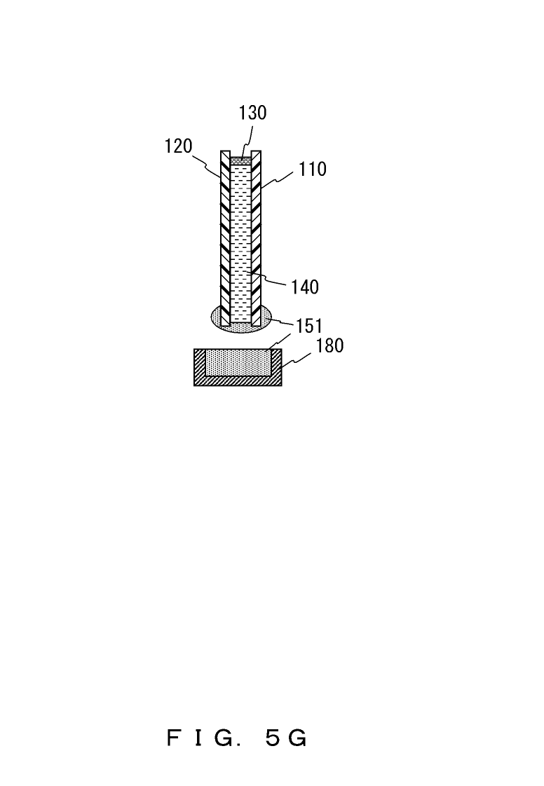

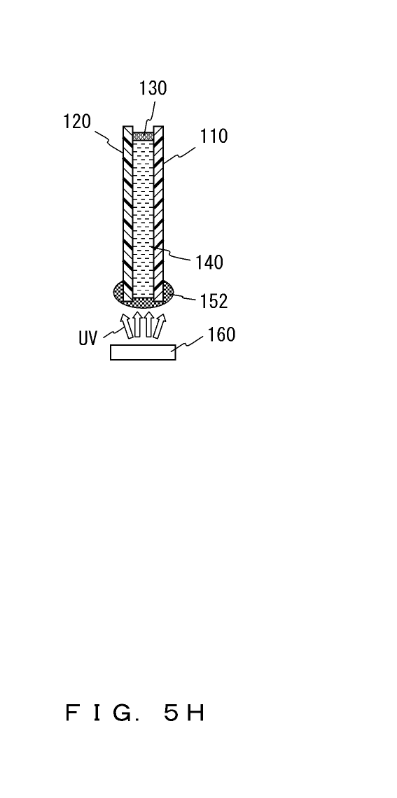

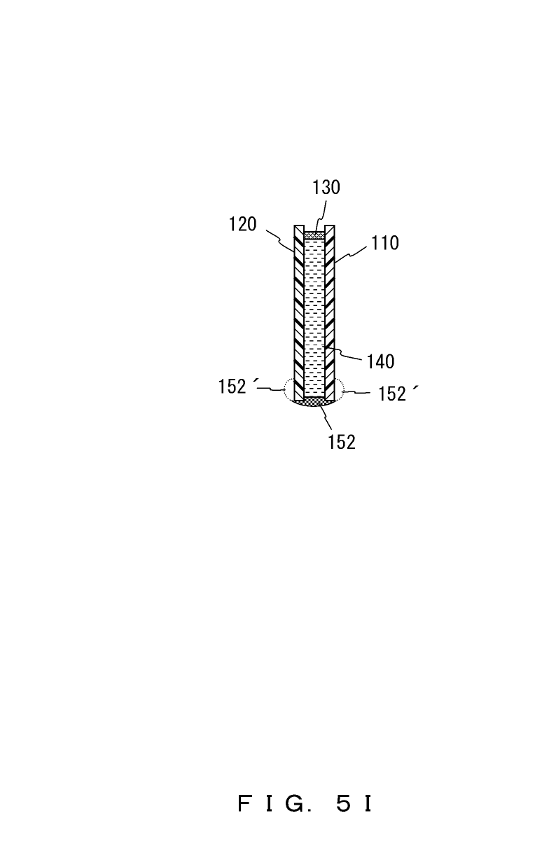

With the method for injecting a liquid crystal material via the opening part 131 arranged in the sealing frame part 130 as described above with reference to FIGS. 4A to 4C and 5A to 5I, the liquid crystal material 140 having an amount that is equal to or larger than that injected into the sealing frame part 130 is needed within the liquid crystal reservoir 170. Normally, there is a problem that the liquid crystal material 140 cannot be used due to a contamination (absorption of water content or the like) if the liquid crystal material 140 is exposed to the air for a longer time period.

Additionally, a step of removing the hardened sealing material 152 is needed, posing a problem that longer time is needed or a problem that the sealing material can be possibly peeled off or the vicinity of the opening part can be broken. The problems associated with the removal of the hardened sealing material can similarly occur also in the method for injecting a liquid crystal material via the opening arranged on the first or the second substrate.

A film substrate liquid crystal sealing method according to an embodiment is described below with reference to the drawings.

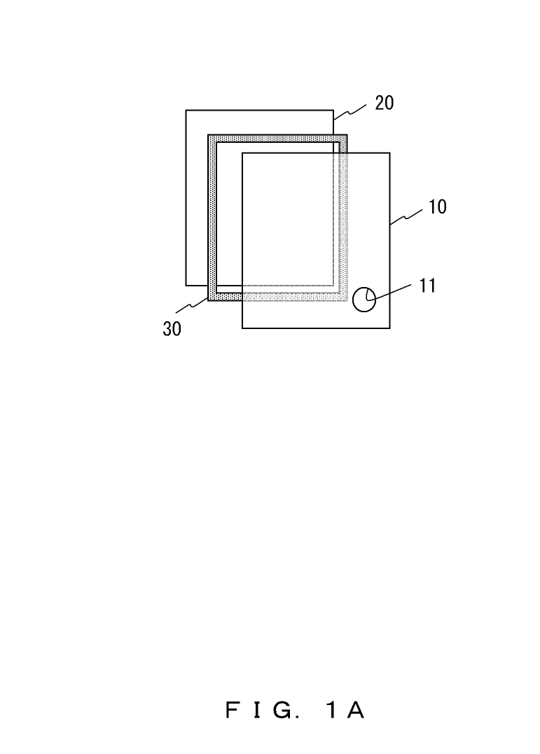

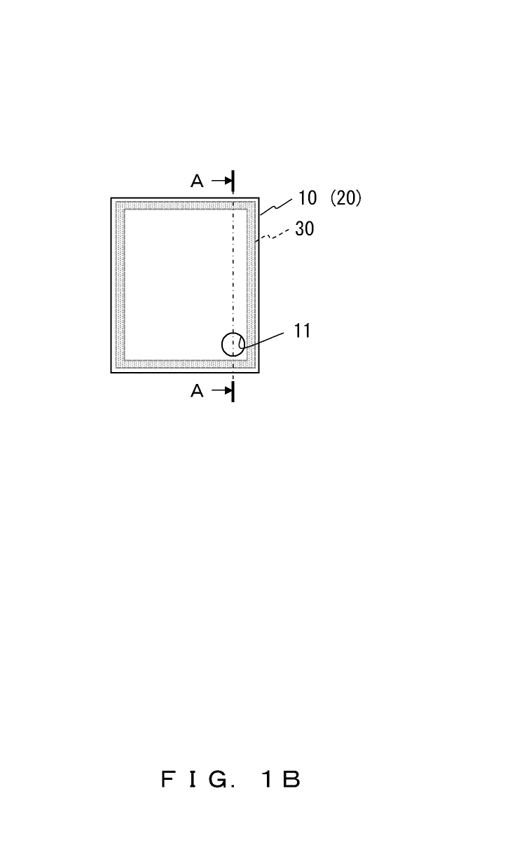

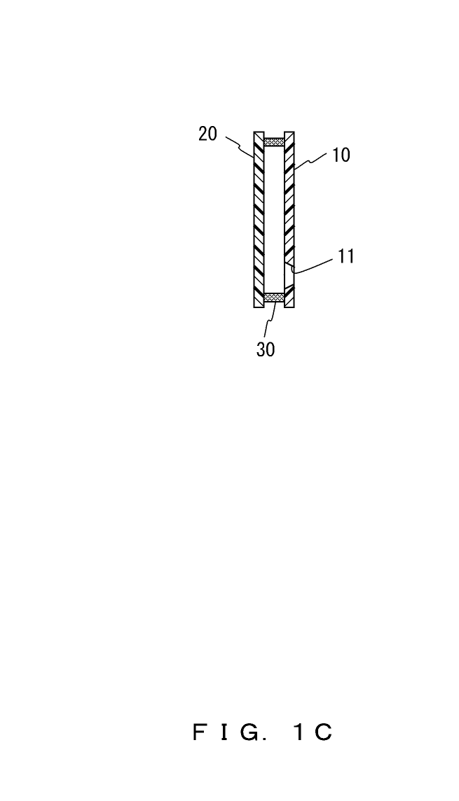

FIGS. 1A and 1B are a disassembly view and a plan view of a film substrate for explaining the liquid crystal sealing method according to the embodiment. FIG. 1C is a cross-sectional view taken along a line A-A of FIG. 1B.

As illustrated in FIGS. 1A to 1C, a first substrate 10 and a second substrate 20, which are respectively made of flexible plastic, are affixed by a rectangular sealing frame part 30 so that transparent electrodes, not illustrated, of the substrates face each other nearly orthogonally. Either of the first substrate 10 and the second substrate 20 does not need to be transparent.

The first substrate 10 is provided with, for example, an opening part 11 having a circular cross-section. The opening part 11 is formed, for example, at one of four corners in a portion as opposed to a region enclosed by the sealing frame part 30. The opening part 11 may be formed not on the first substrate 10 but on the second substrate 20, or on both of the first substrate 10 and the second substrate 20. Moreover, the number of opening parts formed, a shape of the opening part 11 are not particularly limited as long as a liquid crystal material and a sealing material, which will be described later, can be injected.

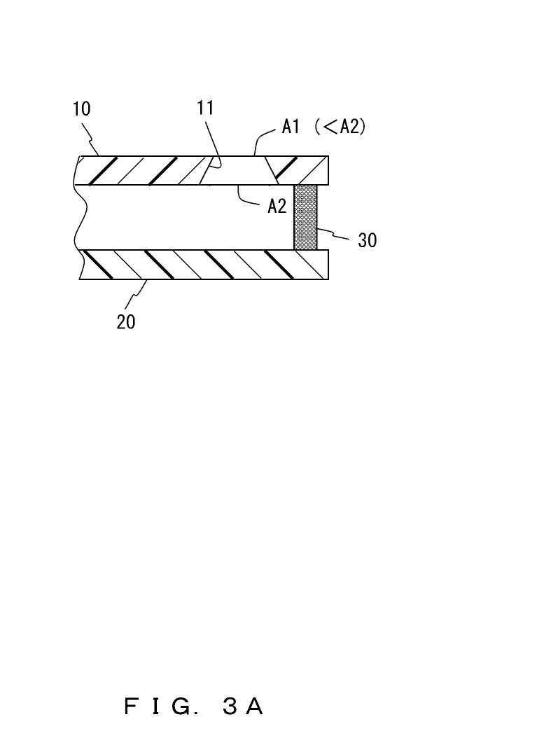

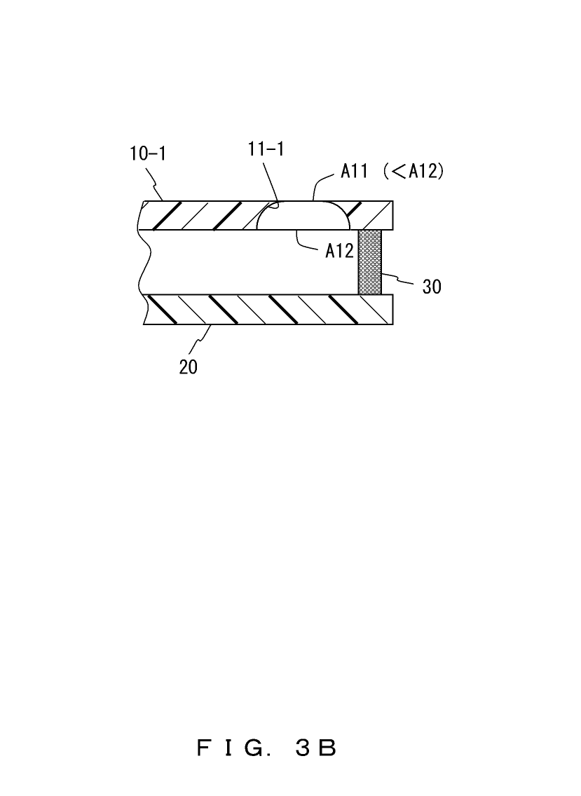

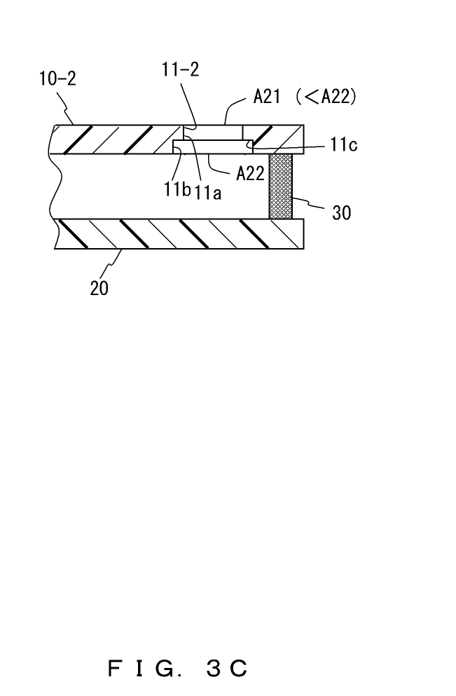

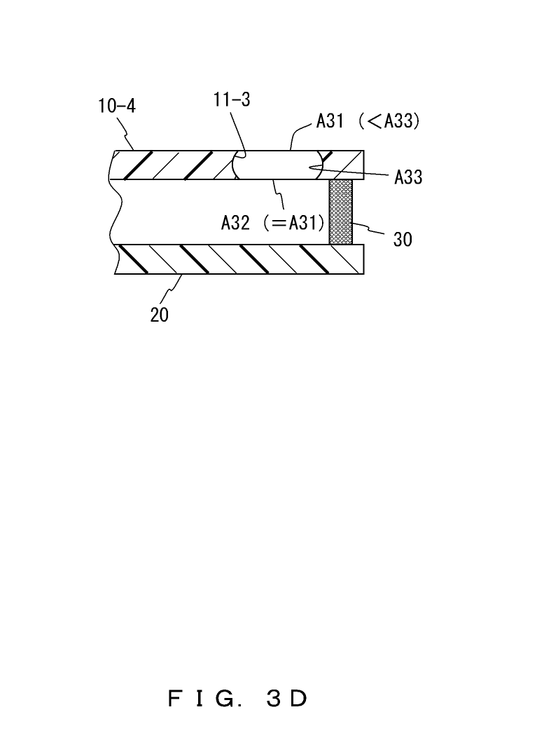

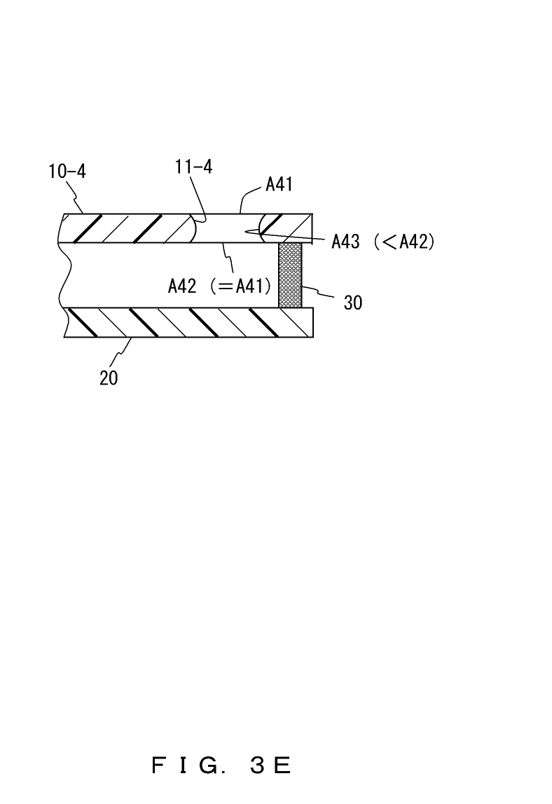

As illustrated in FIG. 3A, a cross-sectional area of an opening area A1 on an external side of the opening part 11 is smaller than an opening area A2 on an internal side (A1<A2), and a cross-sectional area decreases gradually from an edge of the internal side (opening area A2) toward an edge of the external side (opening area A1) as will be described later.

The sealing frame part 30 in this embodiment seals the liquid crystal material to be described later between the first substrate 10 and the second substrate 20, and affixes the first substrate 10 and the second substrate 20 as described above.

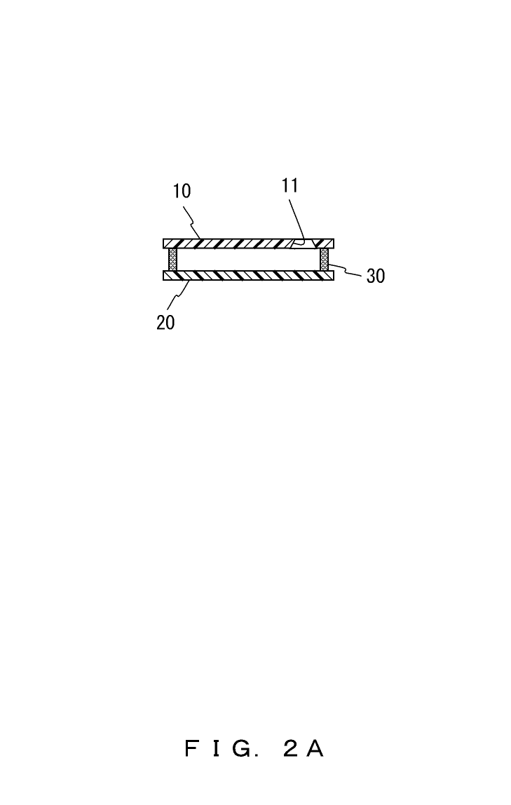

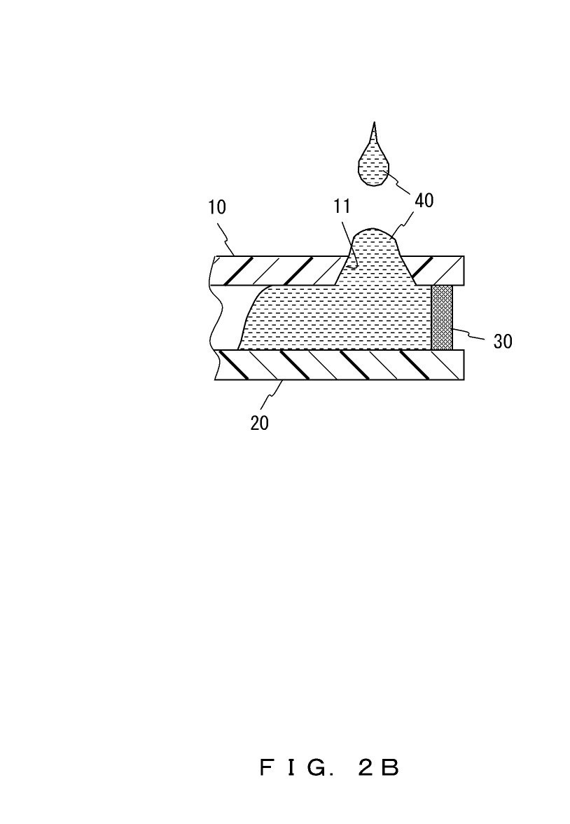

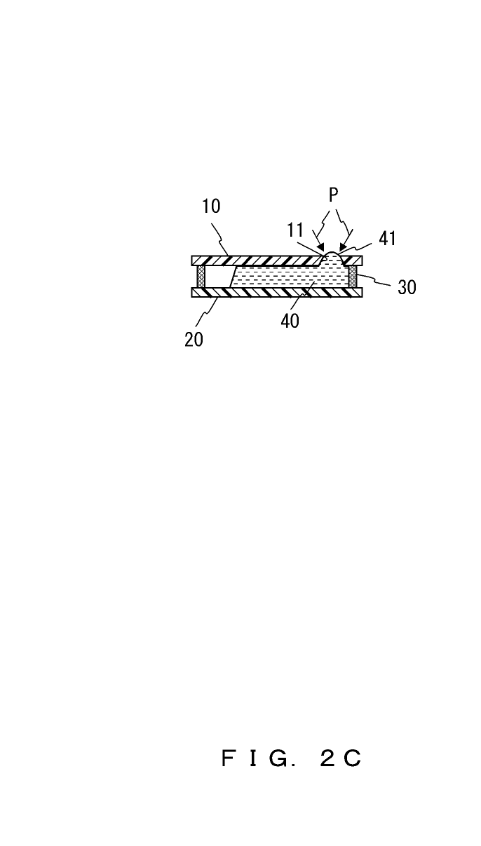

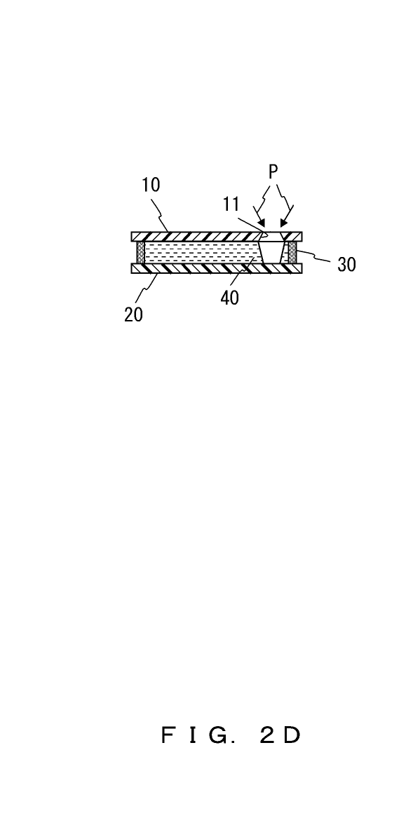

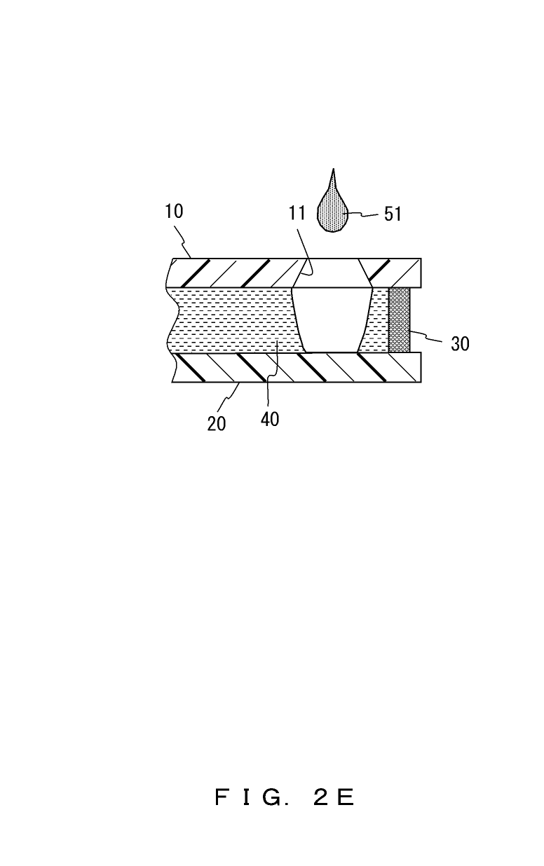

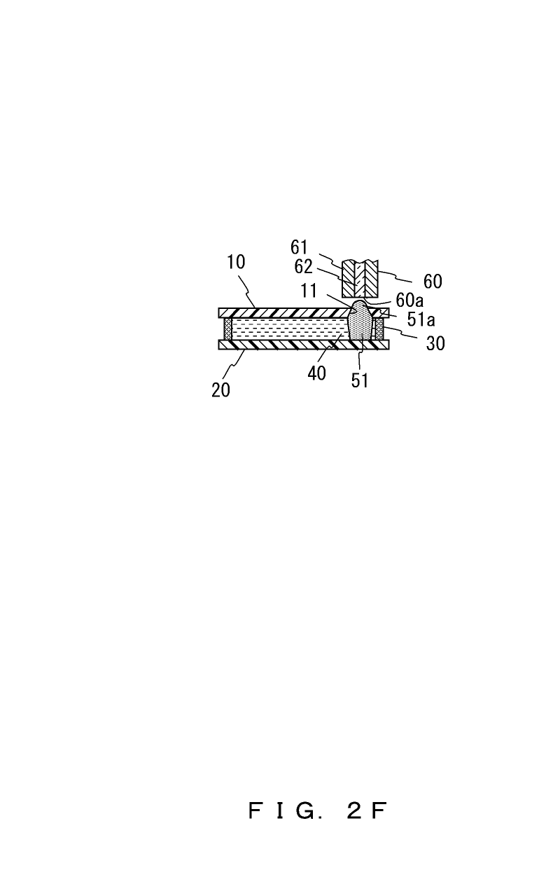

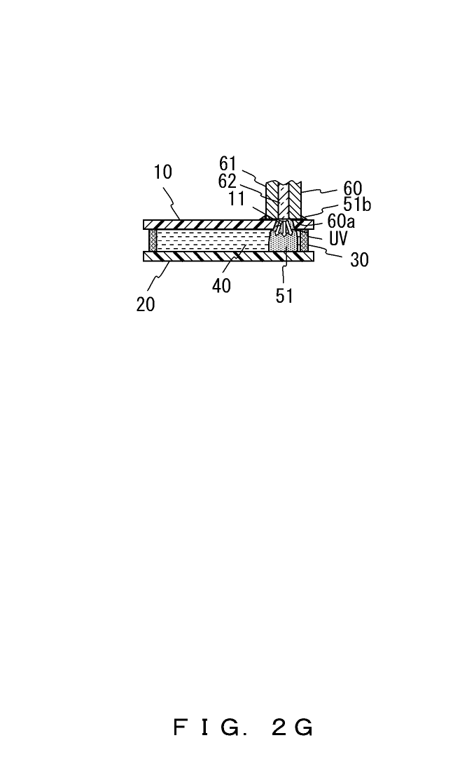

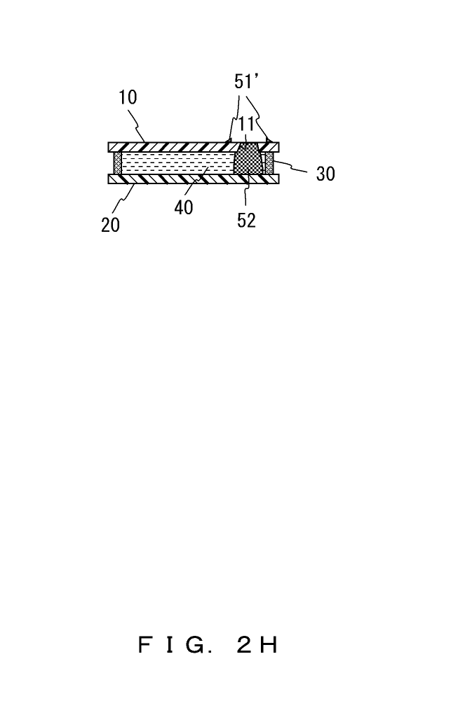

FIGS. 2A to 2H are cross-sectional views for explaining the liquid crystal sealing method according to the embodiment.

As illustrated in FIG. 2A, the first substrate 10 and the second substrate 20, which are affixed by the sealing frame part 30, are depressurized by depressurizing means, not illustrated, so that the inside of the sealing frame part 30 enters, for example, in a vacuum state.

Then, as illustrated in FIG. 2B, the liquid crystal material 40 is injected between the first substrate 10 and the second substrate 20 via the opening part 11, for example, by being dripped while the first substrate 10 and the second substrate 20 are in the depressurized state (liquid crystal material injection step).

As illustrated in FIG. 2C, the depressurized state is released to a normal pressure state, and also a protrusion part 41 of the liquid crystal material 40, which does not fit within the opening part 11, is filled within the sealing frame part 30 by an outside atmospheric pressure P. Then, the liquid crystal material 40 is filled within the entire sealing frame part 30 as illustrated in FIG. 2D.

Next, as illustrated in FIG. 2E, the sealing material 51 that seals the liquid crystal material 40 is coated (injected), for example, by being dripped from the opening part 11 (sealing material injection step).

A protrusion part 51a that is injected in this way and protrudes from the opening part 11 of the sealing material 51 as illustrated in FIG. 2F is flattened by a pressing member 60 toward the inside of the opening part 11. When the protrusion part 51a is flattened, the sealing material 51 is flattened (pressed down) to be clipped so that the pressing member 60 makes contact with the edge (the opening area A1 in FIG. 3A) of the external side of the opening part 11, and an unneeded sealing material 51 is made to go out of the pressing member 60.

Additionally, a hardening mechanism (hardening means) is embedded in the pressing member 60. Only the sealing material 51 at the opening part 11 is hardened in the state where the sealing member 51 is being pressed down, whereby the unneeded sealing material 51 can be easily removed in an unhardened state.

Note that the pressing member 60 has, at its bottom, a flat surface part 60a that is larger than the opening area A1, illustrated in FIG. 3A, of the edge on the external side of the opening part 11. If a diameter of the opening area A1 is 2 mm, it is preferable to make the diameter of the plane part 60a, for example, but not particularly limited to, larger than 2 mm and equal to or smaller than 10 mm. The pressing member 60 includes, for example, a cylinder tube 61, and a light guiding part 62 such as an optical fiber within the tube 61. A pressing surface of the pressing unit 60 is a flat surface.

As illustrated in FIG. 2G, only the portion injected via the opening part 11 of the sealing material 51 is hardened in the flattened state unchanged by being irradiated with an ultraviolet ray UV that is guided by the light guiding part 62 (sealing material hardening step).

Note that the pressing member 60 does not always need to irradiate the sealing material 51 portion with light. For example, a light irradiation part different from the pressing member 60 may irradiate the sealing material 51 portion with light, for example, from a side as opposed to the substrate without hardening the sealing material 51b that protrudes externally to the pressing member 60, for example, in a state where the transparent pressing member 60 flattens the protrusion part 51a of the sealing material 51. Moreover, the sealing material 51 may be hardened with light other than an ultraviolet ray, a chemical reaction, heat, or the like. Especially, if the sealing material 51 is hardened with heat, it is preferable to take measures such as heat insulation so as to prevent heat from being transferred to the other members such as the sealing material 51′ external to the opening part 11, the first substrate 10 and the like.

As illustrated in FIG. 2H, after the sealing material 51 injected via the opening part 11 is hardened with the ultraviolet ray (hardened sealing material 52), an unhardened sealing material 51′ external to the opening part 11 is removed, for example, by being wiped. As a result, the sealing of the liquid crystal material 40 on the film substrate (liquid crystal panel) is complete.

First to fourth modification examples of this embodiment are described next.

FIGS. 3A to 3E are cross-sectional views for explaining shapes of the opening part 11 in this embodiment and the first to the fourth modification examples of this embodiment.

In the above described opening part 11 illustrated in FIG. 3A, the opening area A1 on the external side is smaller than the opening area A2 on the internal side (A1<A2), and a cross-sectional area decreases gradually from the edge (opening area A2) of the internal side toward the edge of the external side (opening area A1) at a certain ratio.

Similarly to the opening part 11 illustrated in FIG. 3A, an opening area All on an external side on an opening part 11-1 of a first substrate 10-1 illustrated in FIG. 3B (first modification example) is smaller than an opening area A12 on an internal side (A11<A12), and a cross-sectional area decreases gradually from an edge (opening area A12) of the internal side toward an edge of the external side. However, since the opening part 11-1 takes the shape of a bowl, the ratio at which the cross-sectional area decreases grows by degrees.

An opening area A21 on an external side of an opening part 11-2 of a first substrate 10-2 illustrated in FIG. 3C (second modification example) is smaller than an opening area A22 on an internal side (A21<A22). The opening part 11-2 has a small-diameter part (small cross-sectional area part) 11a on the external side, a large-diameter part (larger cross-sectional area part) 11b on the internal side, and a level difference part (portion where the cross-sectional area decreases from the internal side to the external side) between the small-diameter part 11a and the large-diameter part 11b.

Although an opening area A31 on an external side of an opening part 11-3 of a first substrate 10-3 illustrated in FIG. 3D (third modification example) is the same as an opening area A32 on an internal side, a cross-sectional area increases halfway from the internal side (maximum cross-sectional area A33), and decreases gradually toward the external side. As described above, the portion from the maximum cross-sectional area A33 up to the opening part (opening area A31) on the external side is the portion where the cross-sectional area decreases gradually from the internal side toward the external side.

Similarly to the opening part 11-3 illustrated in FIG. 3D, also an opening area A41 on an external side of an opening part 11-4 of a first substrate 10-4 illustrated in FIG. 3E (fourth modification example) is the same as an opening area A42 on an internal side. However, a cross-sectional area of the opening part 11-4 decreases halfway from the internal side (minimum cross-sectional area A43), and thereafter increases toward the external side. As described above, the portion from the internal side (opening area A42) to the minimum cross-sectional area A43 is the portion where the cross-sectional area decreases gradually from the internal side to the external side.

In the above described embodiment, a film substrate manufacturing method includes a sealing material hardening step of pressing down the portion (protrusion part 51a) that protrudes from the opening part 11 of the sealing material 51 toward the inside of the opening part 11 with the pressing member 60, and of hardening the sealing material 51 in the pressed state.

Accordingly, the liquid crystal reservoir 170 and the sealing material reservoir 180, which are intended to inject a liquid crystal or coat a sealing material, can be omitted. Moreover, since the sealing material 51 is hardened by being flattened toward the inside of the opening 11 with the pressing member 60, a labor of removing a hardened sealing material can be saved.

Additionally, according to this embodiment, the quantity of the liquid crystal material 40 used can be reduced, and the operation of removing the sealing material 51 can be easily performed.

Furthermore, in this embodiment, the opening parts 11 illustrated in FIGS. 3A to 3E have the portion where the cross-section area decreases gradually from the internal side toward the external side. Accordingly, retention force for retaining the sealing material 51 hardened at the opening part 11 so as to prevent the sealing material 51 from going out of the opening part 11 can be strengthened.

Still further, in this embodiment, the opening area A1, A11, or A21 on the external side of the opening part 11 illustrated in FIGS. 3A and 3C is smaller than the opening area A2, A12 or A22 on the internal side. Therefore, retention force for retaining the sealing material 51 hardened at the opening part 11 so as to prevent the sealing material 51 from going out of the opening part 11 can be further strengthened.

Still further, in this embodiment, the cross-sectional area of the opening part 11 illustrated in FIGS. 3A and 3B decreases gradually from the edge of the internal side (opening area A2, A12) toward the edge of the external side (opening area A1, A11). Accordingly, retention force for retaining the sealing material 51 hardened at the opening part 11 so as to prevent the sealing material 51 from going out of the opening part 11 can be further strengthened.

Still further, in this embodiment, only the portion of the sealing member 51, which is injected via the opening part 11, is hardened by being irradiated with light in the sealing material hardening step. Therefore, the sealing material 51′ external to the opening part 11 is unhardened, whereby the operation of removing the sealing material 51′ external to the opening part 11 can be more easily performed.

Still further, in this embodiment, the portion (protrusion part 51a) that protrudes from the opening part 11 of the sealing material 51 is flattened toward the inside of the opening part 11 with the pressing member 60 having the flat surface part 60a that is larger than the opening area (A1 or the like) on the external side of the opening part 11 in the sealing material hardening step. Accordingly, the protrusion part 51a of the sealing material 51 can be securely flattened with the flat surface part. Moreover, since the hardened surface of the sealing material is the same as the film substrate and the overflowing sealing material 51 is unhardened, the operation of removing the sealing material 51 can be more easily performed.

Note that the type of hatching does not impose limitations on a material although the cross-sections are hatched in the drawings.

What is claimed is:

1. A film substrate liquid crystal sealing method, comprising:
injecting a liquid crystal material between a first substrate and a second substrate via an opening part formed on the first substrate, the second substrate or combination thereof;
injecting a sealing material for sealing the liquid crystal material injected in the injecting of the liquid crystal material via the opening part; and
hardening the sealing material in a pressed state by pressing down a portion that protrudes from the opening part of the sealing material injected in the injecting of the sealing material toward an inside of the opening part with a pressing member.

2. The film substrate liquid crystal sealing method according to claim 1, wherein
the opening part has a portion where a cross-sectional area decreases gradually from an internal side to an external side.

3. The film substrate liquid crystal sealing method according to claim 2, wherein
an opening area on the external side of the opening part is smaller than an opening area of the internal side.

4. The film substrate liquid crystal sealing method according to claim 3, wherein
the cross-sectional area of the opening part decreases gradually from an edge of the internal side toward an edge of the external side.

5. The film substrate liquid crystal sealing method according to claim 1, wherein
only the portion of the sealing material, which is injected via the opening part, is hardened in the hardening of the sealing material.

6. The film substrate liquid crystal sealing method according to claim 1, wherein
the portion that protrudes from the opening part of the sealing material is flattened toward the inside of the opening part with the pressing member having a flat surface part that is larger than an opening area on an external side of the opening part in the hardening of the sealing material.

7. The film substrate liquid crystal sealing method according to claim 1, wherein
the pressing member hardens the sealing material.
